(19) United States
(12) Patent Application Publication
(10) Pub. No.: US 2007/0075925 A1
(43) Pub. Date: Apr. 5, 2007

(54) Method for Prevention of Distorted Sub-Picture Display on a Flat Panel Display

(75) Inventors: Shao-Ping Hung, Taipei City (TW); Shang-Ping Tang, Hsinchu City (TW)

Correspondence Address: CONNOLLY BOVE LODGE & HUTZ LLP, P.O. BOX 2207, WILMINGTON, DE, 19899-2207, US

(73) Assignee: MYSON CENTURY, INC., Hsinchu (TW)

(21) Appl. No.: 11/164,633

(22) Filed: Nov. 30, 2005

(30) Foreign Application Priority Data
Oct. 5, 2005 (TW) 094134771

(51) Int. Cl. G09G 3/28; G09G 3/36

(52) U.S. Cl. 345/63; 345/87

(57) ABSTRACT

The present invention discloses a method for prevention of distorted sub-picture display on a flat panel display. The display image of the flat panel display comprises a main picture and a sub-picture. While a drop line is performed on the main picture, image data output of the sub-picture is stopped. As the drop line is finished, image data output of the sub-picture is resumed. The method of stopping the output of image data of the sub-picture is adopted as a way to stop outputting a timing control signal used for controlling the image data output of the sub-picture, wherein the timing control signal is a horizontal synchronization signal or a clock signal. The timing control signal does not change logic state level while the drop line occurs. The image data of the sub-picture will not be discarded or masked while the drop line occurs. This prevents a distorted sub-picture on the flat panel display.

### BACKGROUND OF THE INVENTION

(A) Field of the Invention

The present invention is related to a display method of a flat panel display, and more specifically to a method for prevention of distorted sub-picture display on the flat panel display.

(B) Description of the Related Art

While a high-resolution picture is displayed on a low-resolution flat panel display, a scaling-down procedure or mask is needed. While line buffers are not sufficient, a drop-line method is usually adopted, i.e., parts of the pixel lines are not displayed on the flat panel display.

Referring to FIG. 1, while a drop line is performed on the main picture 10, if image data of a sub-picture, e.g., on screen display (OSD), outputs continuously, it will discard or mask parts of the image data of the sub-picture and lead to a distorted sub-picture display. A sub-picture 12 in FIG. 1 shows an example of distorted display.

### SUMMARY OF THE INVENTION

The objective of the present invention is to provide a method for improvement of distorted sub-picture display on the flat panel display, thereby obtaining better display quality.

To achieve the above objective, the present invention discloses a method for prevention of distorted sub-picture display on the flat panel display. The display image of the flat panel display comprises a main picture and a sub-picture. While a drop line is performed on the main picture, image data output of the sub-picture is stopped. As the drop line is finished, image data output of the sub-picture is resumed. As a result, the image data of the sub-picture will not be discarded or masked while a drop line on a main picture is performed. Also, this prevents a distorted sub-picture on the flat panel display.

The method of stopping the output of image data of the sub-picture is adopted as a way to stop outputting a timing control signal used for controlling the image data output of the sub-picture, wherein the timing control signal is a horizontal synchronization signal or a clock signal. The timing control signal does not change the logic state level while the drop line occurs. The timing control signal is generated by a sub-picture timing control unit and is supplied to a sub-picture generation unit. The sub-picture generation unit supplies image data of the sub-picture to an image processing unit. Image data of the sub-picture and a main picture are inputted to the image processing unit and processed by the image processing unit. The image processing unit supplies processed image data to a display unit and then the display unit displays a main picture and a sub-picture.

To be more specific, the method of the present invention is that before performing a drop line, the sub-picture timing control unit is notified to stop generating the horizontal synchronization signal HS or the clock signal CLK. As a result, the sub-picture generation unit stops supplying image data to the image processing unit such that the image data supplied by the sub-picture generation unit will not be discarded or masked while a drop line occurs, thereby avoiding a distorted sub-picture on the display unit. As the drop line is finished, the sub-picture timing control unit is notified to resume generating the horizontal synchronization signal or the clock signal.

### BRIEF DESCRIPTION OF THE DRAWINGS

FIG. 1 shows a display image on the flat panel display of a background art;

FIG. 2 shows a block diagram of the flat panel display operation in accordance with the present invention;

FIG. 3(a) and FIG. 3(b) show waveform diagrams of horizontal synchronization signals HS of the present invention and background art;

FIG. 4(a) and FIG. 4(b) show other waveform diagrams of horizontal synchronization signals of the present invention and a background art;

FIG. 5(a) and FIG. 5(b) show waveform diagrams of clock signals of the present invention and background art;

FIG. 6 shows a display image on the flat panel display in accordance with the present invention; and

FIG. 7 shows another block diagram of the flat panel display operation in accordance with the present invention.

### DETAILED DESCRIPTION

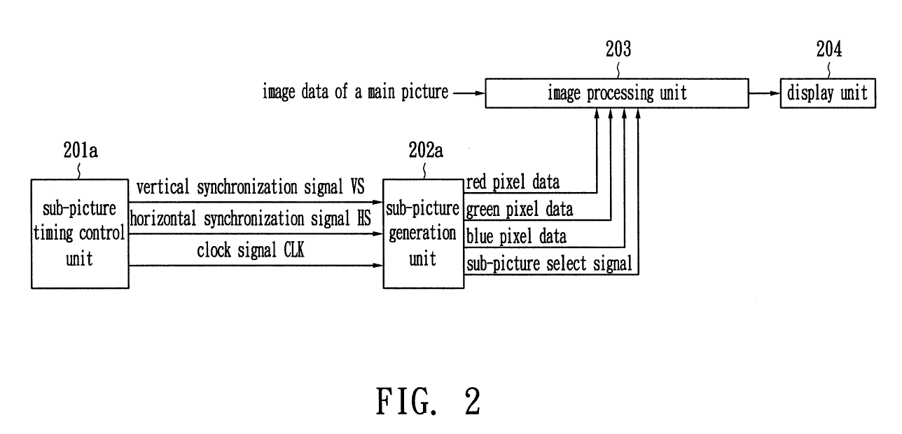

FIG. 2 shows a block diagram of the flat panel display operation in accordance with a preferred embodiment of the present invention. The block diagram comprises a sub-picture generation unit 202a, a sub-picture timing control unit 201a, an image processing unit 203 and a display unit 204. The sub-picture applied to the present invention may be an OSD or another type.

The sub-picture timing control unit 201a supplies a horizontal synchronization signal HS, a vertical synchronization signal VS and a clock signal CLK to the sub-picture generation unit 202a. The sub-picture generation unit 202a supplies image data including red pixel data, green pixel data and blue pixel data to the image processing unit 203. The image processing unit 203 selects image data either from a main picture or the sub-picture generation unit 202a by a sub-picture select signal. The image processing unit supplies processed image data to the display unit 204 and then the display unit 204 displays a main picture and a sub-picture.

The image processing unit 203 comprises a function of drop line control. Before performing a drop line on a main picture, the sub-picture timing control unit 201a is notified to stop generating the horizontal synchronization signal HS or the clock signal CLK. As a result, the sub-picture generation unit 202a stops supplying image data to the image processing unit 203 such that the image data supplied by the sub-picture generation unit 202a will not be discarded or masked while a drop line on a main picture is performed, thereby avoiding a distorted sub-picture on display unit 204. As the drop line is finished, the sub-picture timing control unit 201a is notified to resume generating the horizontal synchronization signal HS or the clock signal CLK.

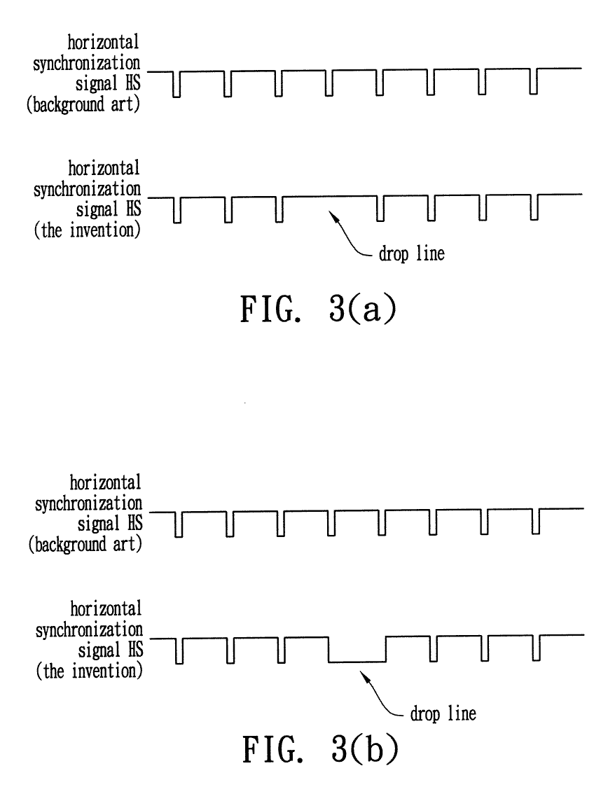

FIG. 3(a) and FIG. 3(b) show waveform diagrams of horizontal synchronization signals HS of the present invention and background art. The signals HS are all activated at a low logic level.

Referring to FIG. 3(a), the sub-picture timing control unit 201a is notified to stop generating the signal HS before the signal HS changes its logic state level, i.e., from high level to low level. The signal HS is kept at a high logic state level while a drop line occurs, and as the drop line is finished, the sub-picture timing control unit 201a resumes generating the signal HS.

Referring to FIG. 3(b), the sub-picture timing control unit 201a is notified to stop generating the signal HS after the signal HS changes its logic state level. The signal HS is kept at a low logic state level while a drop line occurs, and as the drop line is finished, the sub-picture timing control unit 201a resumes generating the signal HS. The method used in FIG. 3(b) achieves a similar result as that used in FIG. 3(a).

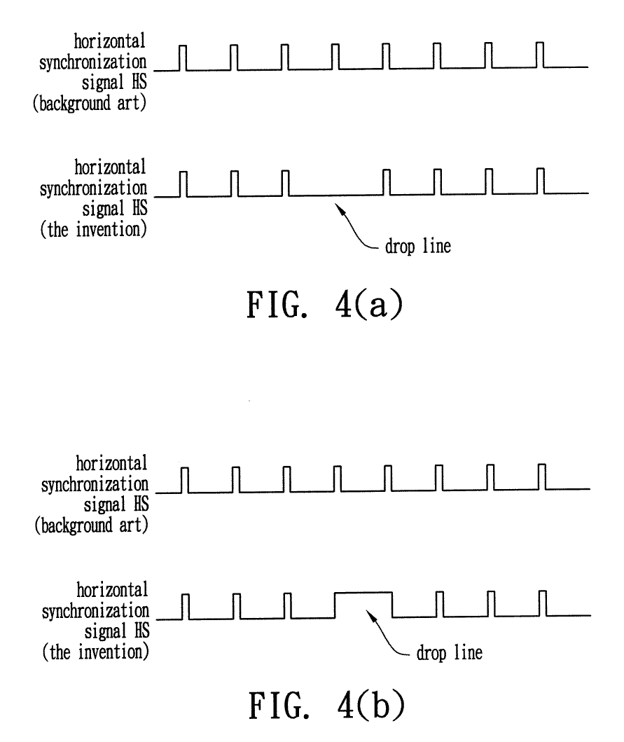

FIG. 4(a) and FIG. 4(b) show waveform diagrams of horizontal synchronization signals HS of the present invention and background art. The signals HS are all activated at a high logic level.

Referring to FIG. 4(a), the sub-picture timing control unit 201a is notified to stop generating the signal HS before the signal HS changes its logic state level, i.e., from low level to high level. The signal HS is kept at a low logic state level while a drop line occurs, and as the drop line is finished, the sub-picture timing control unit 201a resumes generating the signal HS.

Referring to FIG. 4(b), the sub-picture timing control unit 201a is notified to stop generating the signal HS after the signal HS changes its logic state level. The signal HS is kept at a high logic state level while a drop line occurs, and as the drop line is finished, the sub-picture timing control unit 201a resumes generating the signal HS. The method used in FIG. 4(b) achieves a similar result as that used in FIG. 4(a).

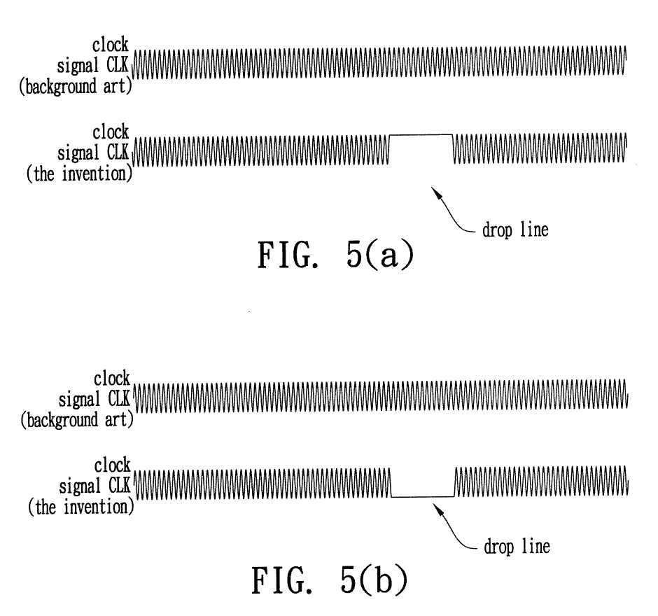

FIG. 5(a) and FIG. 5(b) show waveform diagrams of clock signals CLK of the present invention and a background art.

Referring to FIG. 5(a), the signal CLK is kept at a high logic state level while a drop line occurs, and as the drop line is finished, the sub-picture timing control unit 201a resumes generating the signal CLK. Referring to FIG. 5(b), the signal CLK is kept at a low logic state level while a drop line occurs, and as the drop line is finished, the sub-picture timing control unit 201a resumes generating the signal CLK.

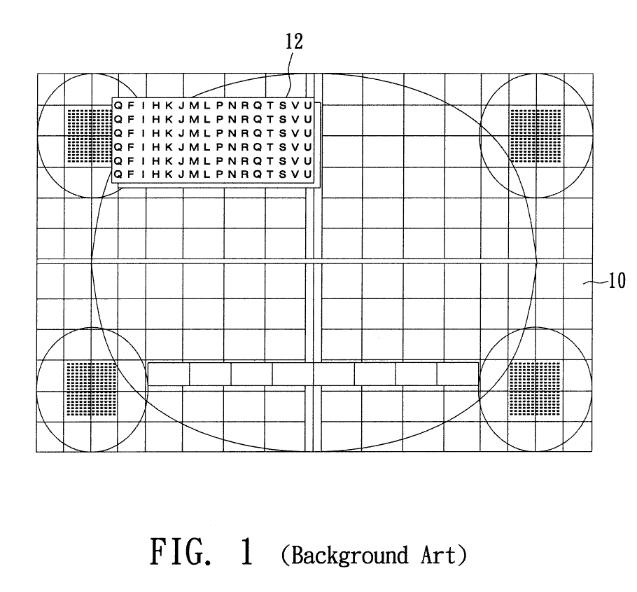

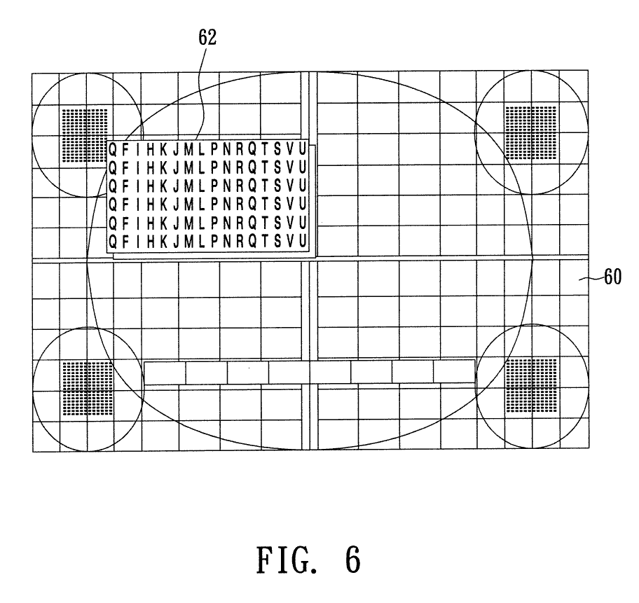

FIG. 6 shows a display image on the flat panel display in accordance with the present invention. The display image comprises a main picture 60 and a sub-picture 62. Comparing sub-picture 62 in FIG. 6 and the sub-picture 12 in FIG. 1, the former shows better display quality than the latter.

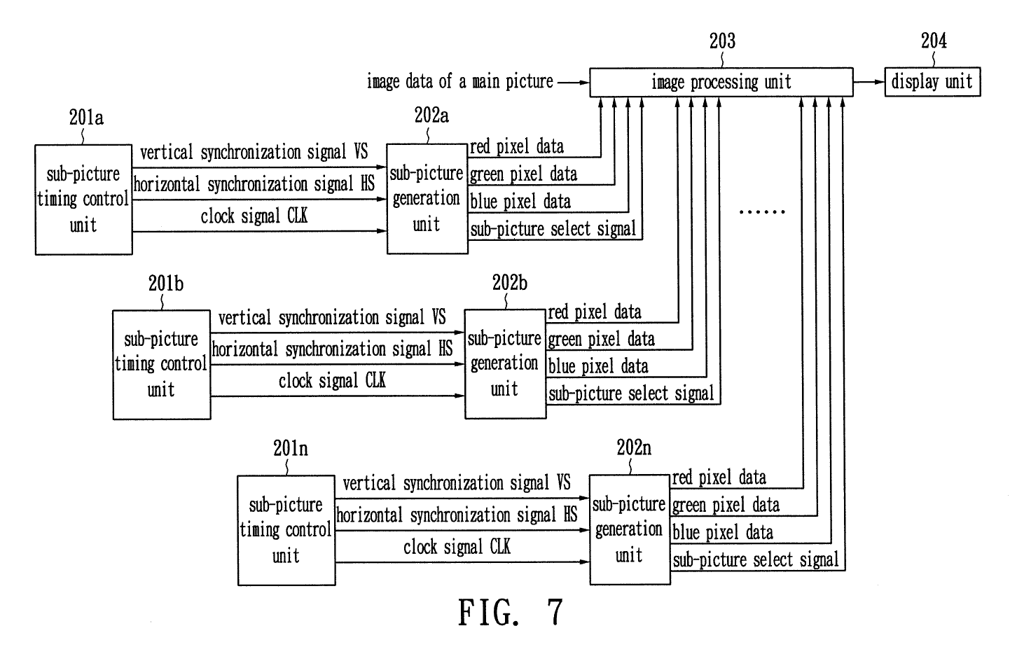

The method of the present invention also applies to a plurality of sub-picture displays. Referring to FIG. 7, a plurality of sub-picture generation units 202a, 202b, . . . 202n, and their corresponding sub-picture timing control units 201a, 201b, . . . , 201n are shown. The method for controlling a plurality of sub-picture displays is the same as that for controlling a sub-picture display described above.

The above-described embodiments of the present invention are intended to be illustrative only. Numerous alternative embodiments may be devised by those skilled in the art without departing from the scope of the following claims.

What is claimed as new and desired to be protected by Letters Patent of the United States is:

1. A method for prevention of distorted sub-picture display on a flat panel display comprising a main picture and a sub-picture, comprising:
stopping an output of image data of the sub-picture while a drop line is performed on the main picture; and
resuming the output of image data of the sub-picture while the drop line operation is finished.

2. The method for prevention of distorted sub-picture display on a flat panel display of claim 1, wherein the step of stopping the output of image data of the sub-picture is adopted as a way to stop outputting a timing control signal used for controlling the image data output of the sub-picture.

3. The method for prevention of distorted sub-picture display on a flat panel display of claim 2, wherein the timing control signal is a horizontal synchronization signal or a clock signal.

4. The method for prevention of distorted sub-picture display on a flat panel display of claim 2, wherein the timing control signal is generated by a sub-picture timing control unit and supplied to a sub-picture generation unit.

5. The method for prevention of distorted sub-picture display on a flat panel display of claim 2, wherein the timing control signal remains the logic state level thereof while the drop line occurs.

6. The method for prevention of distorted sub-picture display on a flat panel display of claim 2, wherein the timing control signal is at a high logic state level if the timing control signal is at a high logic state level when the drop line starts.

7. The method for prevention of distorted sub-picture display on a flat panel display of claim 2, wherein the timing control signal is a low logic state level if the timing control signal is at a low logic state level when the drop line starts.

8. The method for prevention of distorted sub-picture display on a flat panel display of claim 4, wherein the sub-picture timing control unit stops generating the timing control signal to the sub-picture generation unit while the drop line occurs.

9. The method for prevention of distorted sub-picture display on the flat panel display of claim 1, wherein the sub-picture is of OSD type.
